(19) United States
(12) Patent Application Publication
(10) Pub. No.: US 2016/0087416 A1
(43) Pub. Date: Mar. 24, 2016

(54) SYSTEM FOR MOUNTING ELECTRICAL BOX

(71) Applicant: Peter A. Vrame, Elk Grove Village, IL (US)

(72) Inventor: Peter A. Vrame, Elk Grove Village, IL (US)

(21) Appl. No.: 14/861,793

(22) Filed: Sep. 22, 2015

Related U.S. Application Data
(60) Provisional application No. 62/054,087, filed on Sep. 23, 2014.

(51) Int. Cl. H02G 3/12

(52) U.S. Cl. CPC H02G 3/125

(57) ABSTRACT

A system for mounting one or more electrical boxes between associated support studs which includes a unitary mounting bracket configured to extend between the associated support studs. The mounting bracket defines one or more box openings for receiving at least one electrical box in operative association therewith, with the system including a faceplate positionable in respective association with each of the electrical boxes, such that the mounting bracket is sandwiched generally between each electrical box and its respective faceplate. Embodiments of the present invention include mounting brackets configured for relatively fixed position of the electrical boxes, as well as an embodiment which facilitates adjustable positioning of the electrical boxes along the length of the unitary mounting bracket of the system.

### TECHNICAL FIELD OF THE INVENTION

The present invention relates to an arrangement for mounting an electrical box between two building support studs or like support members, and more particularly to an electrical box mounting system including a one-piece, unitary mounting bracket, with an associated electrical box and plaster ring being mounted on the unitary bracket for adjustable and versatile mounting one or more electrical boxes in position between the support studs.

### BACKGROUND OF THE INVENTION

In virtually any building or like structure, mounting of electrical boxes for electrical sockets, switches, junctions or the like is required throughout the structure. Typically, the electrical boxes are positioned and mounted between a pair of laterally spaced apart support studs of the structure, with each electrical box ordinarily receiving a faceplate, sometimes referred to as a mud ring or plaster ring, at its exterior face to permit finish of the interior surface of the structure.

Heretofore, various arrangements have been known for effecting mounting of electrical boxes in such applications. Such arrangements are shown in U.S. Pat. No. 5,330,137, and U.S. Pat. No. 6,666,419, both hereby incorporated by reference. However, a key aspect of installation of such electrical components relates to efficient and versatile mounting on associated support studs or the like. It is not unusual for a building to include dozens, or even hundreds, of electrical boxes that must be stably mounted, and any savings in time and cost in connection with the installation of each electrical box can potentially result in significant savings in time and costs for installation of the building's electrical system.

The present invention contemplates an arrangement to facilitate efficient and stable mounting of electrical boxes in a building or other structure.

### SUMMARY OF THE INVENTION

In accordance with the present, a system for mounting at least one electrical box includes a one-piece unitary mounting bracket which is positionable to extend between a pair of associated vertically extending support studs in a building or other structure. The mounting bracket is used in combination with at least one mounting box positionable between the support studs, with a faceplate being positioned generally at the face of the electrical box such that the mounting bracket is sandwiched generally therebetween. Efficient and versatile mounting of the electrical boxes can be effected, with features of the system facilitating mounting of the electrical boxes between support studs which may vary in spacing.

In accordance with illustrated embodiments, the present mounting system includes a generally rectangular, unitary mounting bracket positionable to extend between two laterally spaced apart associated support studs. The unitary mounting bracket can be dimensioned to extend between associated support studs positioned at any one of various standardized spacings.

The unitary mounting bracket includes an upper marginal portion, and a lower marginal portion extending in parallel relationship beneath the upper marginal portion. The mounting bracket further includes a pair of laterally spaced mounting flanges for respective securement to the pair of laterally spaced apart support studs, with the upper and lower marginal portions extending between pair of mounting flanges in co-planar relationship therewith.

The unitary mounting bracket defines at least one box opening for receiving an electrical box, with the system further including at least one electrical box mounted on the mounting bracket so that the electrical box projects generally rearwardly of box opening of the mounting bracket for disposition of the electrical box between said associated support studs. At least one faceplate, sometimes referred to as a mud ring or plaster ring, is respectively positioned in association with the electrical box so that the upper and lower marginal portions of the mounting bracket are positioned and sandwiched between each of the electrical boxes and the respective one of the faceplates.

In the illustrated embodiment, each of the upper and lower marginal portions of the mounting bracket includes a respective linear edge portion, with each of laterally spaced mounting flanges including upper and lower edges that respectively extend from said linear edge portions and taper toward each other.

In certain embodiments, the at least one box opening defined by the mounting bracket is defined by inwardly tapered, upper and lower inner edges generally at opposite ends of the box opening. In these embodiments, the mounting bracket defines a plurality of the box openings positioned in laterally spaced relationship to each other, with each of the box openings being defined by inwardly tapering, upper and lower inner edges at opposite ends of each of the box openings.

In accordance with the illustrated embodiments, the unitary mounting bracket defines at least one mechanical fastener opening positioned adjacent to the inwardly tapering, upper and lower inner edges at opposite ends of each of the box openings.

Versatile mounting of the unitary mounting bracket on the associated support studs in facilitated by configuring each of the laterally opposite mounting flanges to define a plurality of mechanical fastener openings aligned along a longitudinal axis of the mounting bracket. This permits the mounting bracket to be laterally adjusted, as desired, for fixedly securing the mounting bracket to the associated support studs.

Stable mounting of the electrical boxes can be enhanced by configuring each of the upper and lower marginal portions of said mounting bracket to include a rearwardly extending flange for rigidification of the mounting bracket.

In certain embodiments, the unitary mounting bracket defines three of the box openings positioned in evenly spaced apart relationship to each other, and centered with respect to the laterally spaced mounting flanges. In other embodiments, the unitary mounting bracket defines four of the box openings in evenly spaced apart relationship to each other, with the box openings being laterally offset toward one of said laterally spaced mounting flanges.

These and other objects, features, and advantages of this invention are evident from the following description of contemplated embodiments of this invention, with reference to the accompanying drawings.

### BRIEF DESCRIPTION OF THE DRAWINGS

FIG. 1 is a fragmentary, perspective view of electrical box mounting system embodying the principles of the present invention according to one contemplated embodiment of this invention, as mounted between two associate building support studs, including an electrical box, and a faceplate;

FIG. 2 is a front plan view of one embodiment of a unitary mounting bracket of the system of the present invention, with the real plan view thereof being essentially identical;

FIG. 3, is a side elevational view of the unitary mounting bracket shown in FIG. 2, with the opposite side elevational view thereof being essentially identical;

FIG. 4 is a front plan view similar to FIG. 2 showing an alternative embodiment of the unitary mounting bracket of the present system, with the rear plan view thereof being essentially a mirror image thereof;

FIG. 5 is front plan view similar to FIG. 2 showing a further alternative embodiment of the unitary mounting bracket of the present system, with the rear plan view thereof being essentially identical;

FIG. 6 is a front plan view of a modified embodiment of the unitary mounting bracket shown in FIG. 2, including upper and lower rearwardly extending flanges;

FIG. 7, is a rear plan view of the unitary mounting bracket shown in FIG. 6;

FIGS. 8 and 9 are top and bottom views thereof; and

FIGS. 10 and 11 are opposite end views thereof.

### DETAILED DESCRIPTION OF THE ILLUSTRATED EMBODIMENTS

While the present invention is susceptible of embodiment in various forms, there is shown in the drawings and will hereinafter be described presently preferred embodiments, with the understanding that the present disclosure is to be considered an exemplification of the invention, and is not intended to limit the invention to the specific embodiments illustrated.

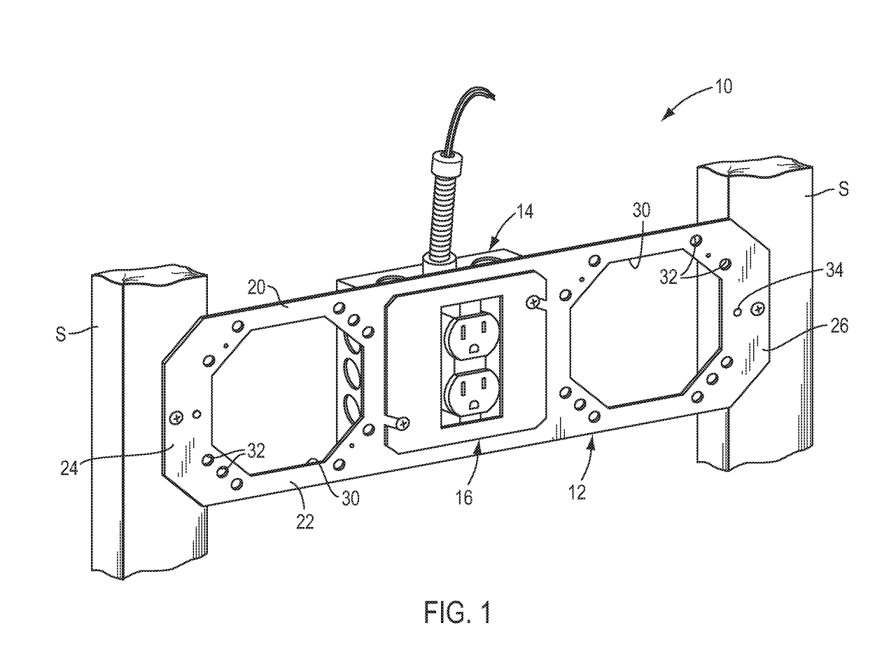

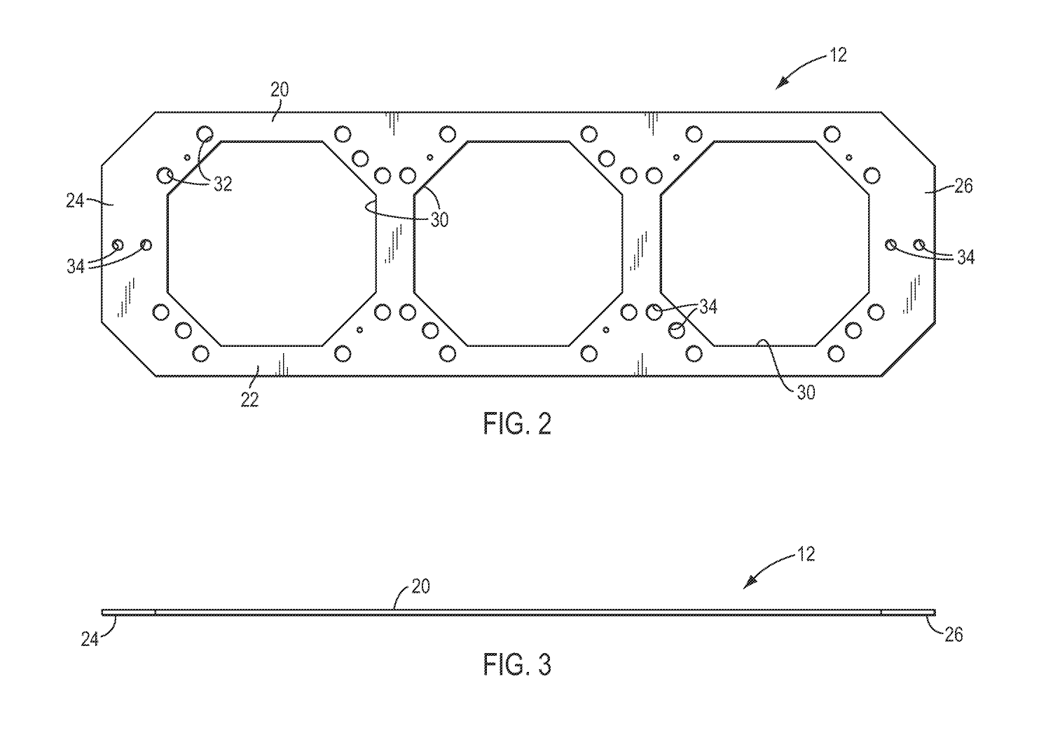

With reference now to FIG. 1, therein is illustrated a system for mounting one or more electrical boxes, generally designated 10, as shown in position with a pair of associated building studs S′. Mounting system 10 is configured for fixedly mounting one or more electrical boxes between the associated studs, as is typically required attended to the installation of an electrical system in a building or like structure. The features of the present system facilitate convenient and efficient mounting of the electrical boxes to the associated support structures and readily accommodate variations in the number, positioning, and orientation of the electrical boxes.

In accordance with the present invention, the present mounting system includes the unitary, one-piece mounting bracket 12 having a generally rectangular, planar elongated configuration. The present system further includes at least one electrical box 14 positionable in operative association with the mounting bracket 12 generally at the rearward surface thereof, and at least one faceplate 16 positioned in association with the electrical box, such that the unitary mounting bracket is positioned in sandwiched relationship generally between the electrical box and faceplate.

As illustrated, the unitary mounting bracket 12 includes an upper marginal portion 20 and a lower marginal portion 22 extending in parallel relationship beneath the upper marginal portion 20. The mounting bracket further includes a pair of laterally spaced mounting flanges 24,26, configured for respective fixed securement to the pair of laterally spaced apart support studs S. The upper and lower marginal portions 20,22 of the support bracket extend between and are unitary with the laterally spaced apart mounting flanges 24,26.

In accordance with the present invention, mounting bracket 12 defines at least one box opening 30 for receiving a respective one of the electrical boxes 14. In this embodiment, three of the box opening 30 are provided in evenly spaced apart relationship to each other, and in centered relationship on the mounting bracket.

As shown in FIG. 1, the electrical box 14 is mounted on the mounting bracket 12 so that the electrical box projects generally rearwardly of a respective one of the box openings 30 defined by the mounting bracket, for disposition of the electrical box generally between the associated support studs S. The faceplate 16 of the assembly is respectively positioned in association with the electrical box 14 so that the upper and lower marginal portions 20,22 of the mounting bracket 12 are positioned generally in sandwiched relationship between the electrical box and the respective faceplate.

In accordance with the preferred features of the present invention, each of the upper and lower marginal portions 20,22 of the unitary mounting bracket 12 include respective linear edge portions, with each of the laterally spaced mounting flanges 24,26 including upper and lower edges that respectively extend from the linear edges of the marginal portions, and tamper toward each other.

In this embodiment, each of the box openings 30 defined by the mounting bracket 12 is defined by inwardly tampered, upper and lower edges generally at opposite ends of the box opening. As will be observed in this embodiment including a plurality of the box openings 30, each of the openings is defined by inwardly tampering, upper and lower edge portions at opposite ends of each of the box openings.

Efficient and versatile mounting of various configurations of the electrical boxes and/or faceplates is facilitated by the provision of at least one mechanical fastener opening 32 positioned adjacent to each of the inwardly tampering, upper and lower edges at opposite ends of each of the box openings 30. Versatile use of the present system is further facilitated by providing each of the mounting flanges 24,26 with a plurality of mechanical fastener openings 34 aligned along a longitudinal axis of the mounting bracket 12.

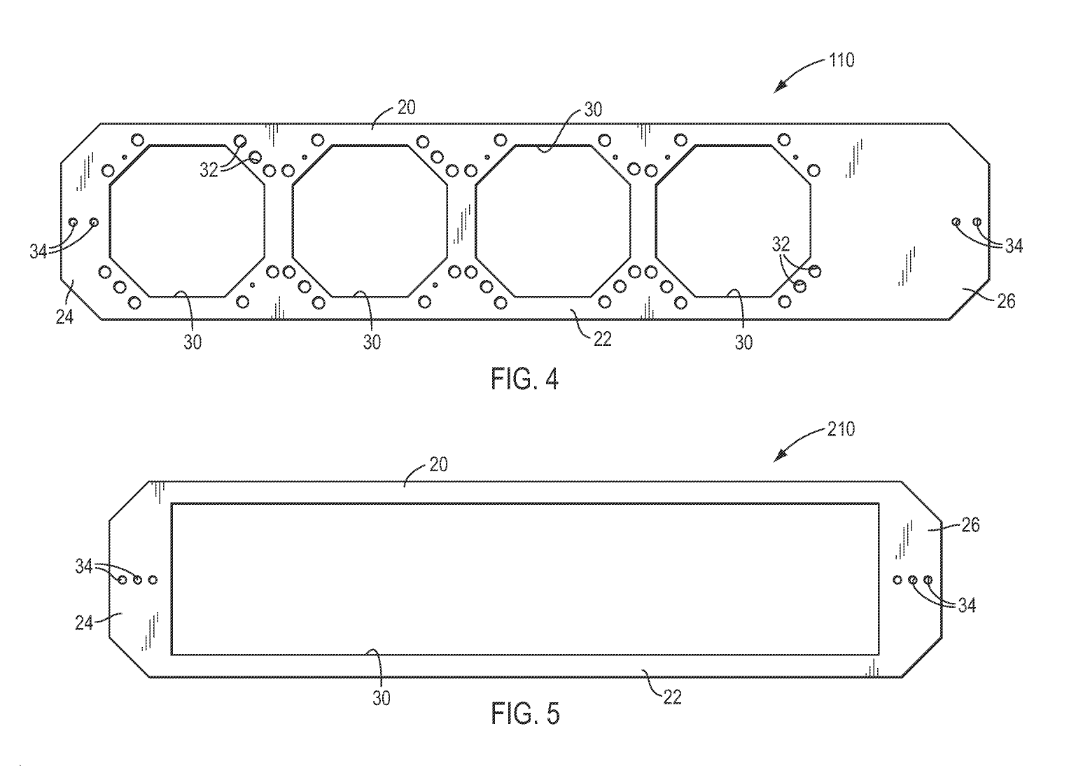

FIG. 4 illustrates a modified embodiment of the unitary mounting bracket, designated 110 of the present mounting system. In this embodiment, four of the box openings 30 are defined by the mounting bracket, with the box openings being positioned in evenly spaced relationship to each other, while being laterally offset toward one of the mounting flanges 24,26 (offset toward mounting flange 24 in this view).

FIG. 5 illustrates a further alternative embodiment of the unitary mounting bracket of the present system, with this embodiment designated 210. This embodiment includes a single relatively enlarged box opening 30 which extends generally between the laterally spaced apart mounting flanges 24,26. The upper and lower marginal portions 20,22 of the unitary mounting bracket 210 are unitarily joined with laterally spaced apart mounting flanges 24,26, with each of the upper and lower marginal portions including respective linear edge portions, and with the mounting flanges 24,26 including upper and lower edges that respectively extend from the linear edge portions and tamper towards each other.

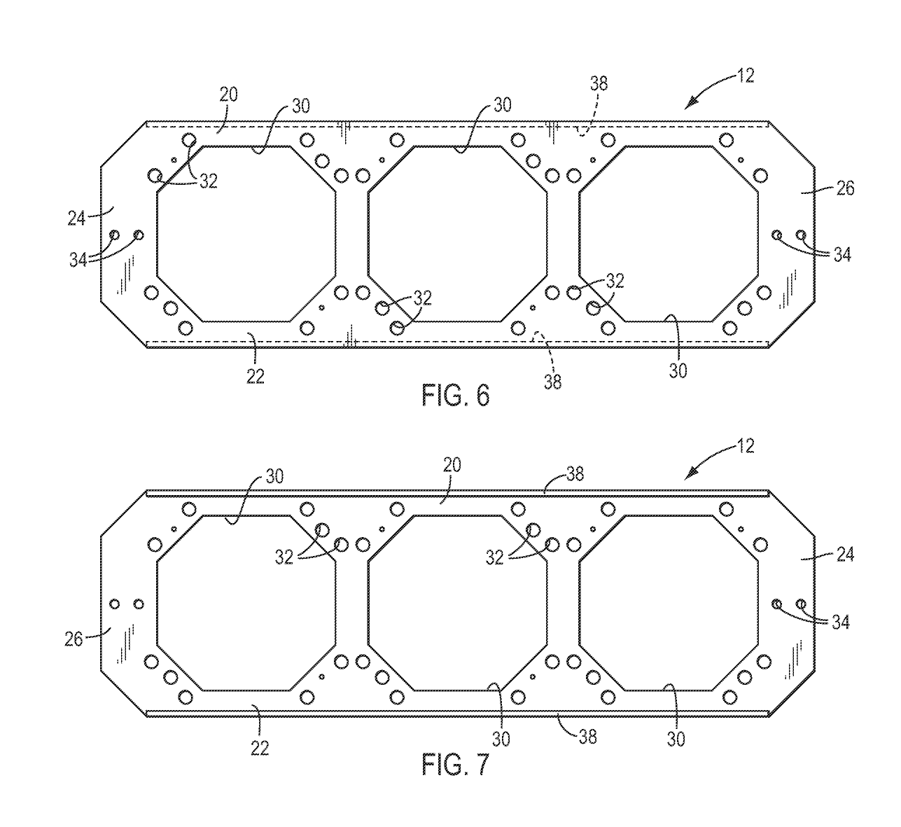

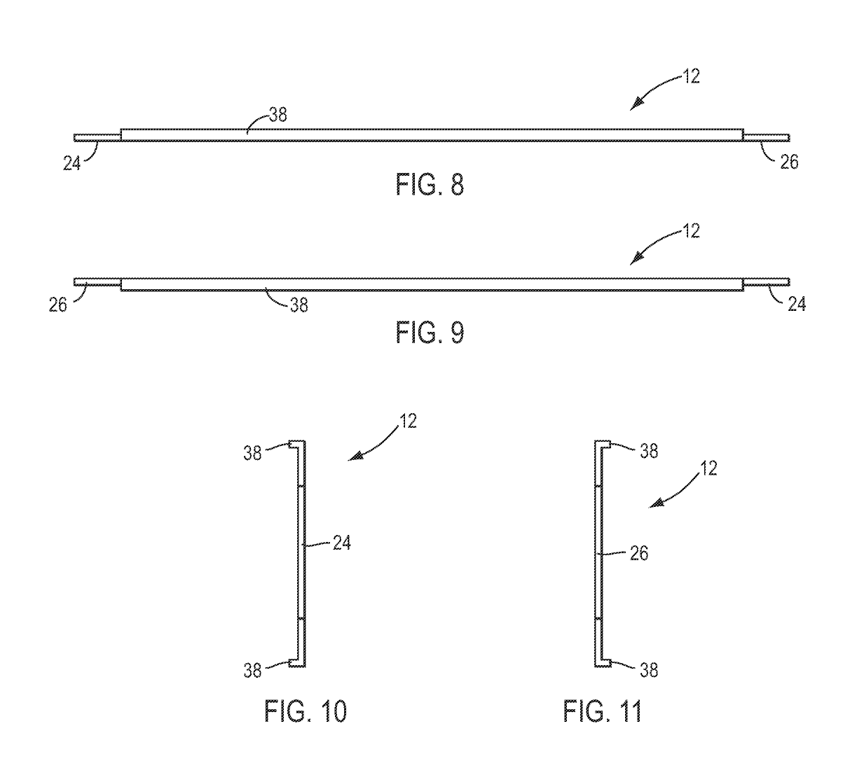

FIG. 6-11 illustrate a modified configuration of the unitary mounting bracket 10, wherein each of the upper and lower marginal portions 20,22 of the mounting bracket include a rearwardly extending flange 38 for rigidification of the mounting bracket.

It will be understood that each of the alternative embodiments of the mounting bracket of the present system, such as illustrated in FIGS. 4 and 5 can be similarly configured so that the upper and lower marginal portions thereof each include a rearwardly extending flange for providing the desired rigidifaction of the mounting bracket.

Mounting of electrical boxes between the associates support studs S, in accordance with the present invention, will be readily appreciated. One or more of the electrical boxes can be mounting to the unitary mounting bracket of the present system, with those embodiments illustrated in FIGS. 1 and 4 configured such that each electrical box 14 is mounting at a relatively fixed position along the length of the associated mounting bracket. Plural ones of the mechanical fastener openings 34 in the mounting flanges 24, 26 facilitate mounting of the system between the associated support studs S. A faceplate 16 is positioned to the generally outwardly facing surface of each mounting bracket 12, in cooperative position with one of the electrical boxes 14, whereby the unitary mounting bracket is sandwiched generally between the electrical box and the faceplate.

As will be appreciated, in the embodiment of the present invention shown in FIG. 5, including a single, elongated box opening 30, one or more electrical boxes, and associated faceplate, can be adjustably and selectively positioned along the length of the box 30. Versatile and efficient mounting of the electrical boxes in position between the support studs is desirably provided.

From the foregoing, it will be observed that numerous modifications and variations can be affected without departing from the true spirit and scope of the novel concept of the present invention. It will be understood that no limitation with respect to the specific embodiments illustrated herein is intended or should be inferred. The disclosure is intended to cover, by the appended claims, all such modifications as fall within the scope of the claims.

What is claimed is:

1. A system for mounting at least one electrical box, comprising:
a generally rectangular, unitary mounting bracket positionable to extend between two laterally spaced apart associated support studs,
said mounting bracket including an upper marginal portion, and a lower marginal portion extending in parallel relationship beneath said upper marginal portion,
said mounting bracket further including a pair of laterally spaced mounting flanges for respective securement to said pair of laterally spaced apart support studs, said upper and lower marginal portions extending between said pair of mounting flanges;
said mounting bracket defining a least one box opening for receiving an electrical box;
at least one electrical box mounted on said mounting bracket so that said electrical box projects generally rearwardly the box opening of said mounting bracket for disposition of said electrical box between said associated support studs, and at least faceplate respectively positioned in association with said at least one electrical box so that said upper and lower marginal portions of said mounting bracket are positioned between each said electrical box and the respective one of said faceplate.

2. A system for mounting at least one electrical box, in accordance with claim 1, wherein
each of said upper and lower marginal portions include respective linear edge portions, each of laterally spaced mounting flanges including upper and lower edges that respectively extend from said linear edge portions and taper toward each other.

3. A system for mounting at least one electrical box, in accordance with claim 2, wherein said at least one box opening defined by said mounting bracket is defined by inwardly tapered, upper and lower inner edges generally at opposite ends of said box opening.

4. A system for mounting at least one electrical box, in accordance with claim 3, wherein
said mounting bracket defines a plurality of said box openings positioned in laterally spaced relationship to each other, each of said openings being defined by inwardly tapering, upper and lower inner edge at opposite ends of each of said openings.

5. A system for mounting at least one electrical box, in accordance with claim 4, wherein
said mounting bracket defines at least one mechanical fastener opening positioned adjacent to each of said inwardly tapering, upper and lower inner edges at opposite ends of each of the openings.

6. A system for mounting at least one electrical box, in accordance with claim 2, wherein
each of said mounting flanges defines a plurality of mechanical fastener openings aligned along a longitudinal axis of said mounting bracket.

7. A system for mounting at least one electrical box, in accordance with claim 6, wherein
each of said upper and lower marginal portions of said mounting bracket includes a rearwardly extending flange for rigidification of the mounting bracket.

8. A system for mounting at least one electrical box, in accordance with claim 4, wherein said mounting bracket defines three of said box openings positioned in evenly spaced apart relationship to each other and centered with respect to said laterally spaced mounting flanges.

9. A system for mounting at least one electrical box, in accordance with claim 1, wherein
said mounting bracket defines four of said box openings in evenly spaced apart relationship to each other, said box openings be laterally offset toward one of said laterally spaced mounting flanges.
